(19) United States
(12) Patent Application Publication
(10) Pub. No.: US 2025/0178049 A1
(43) Pub. Date: Jun. 5, 2025

(54) SOIL MIXING PROCESSES FOR STABILIZING CONTAMINATED SOIL WHILE MITIGATING DUST SCATTER

(71) Applicant: Regenesis Bioremediation Products, San Clemente, CA (US)

(72) Inventors: Paul R. Erickson, San Clemente, CA (US); Chase Hartsell, San Clemente, CA (US); Yen-Ling Liu, San Clemente, CA (US)

(21) Appl. No.: 18/953,441

(22) Filed: Nov. 20, 2024

Related U.S. Application Data
(60) Provisional application No. 63/604,656, filed on Nov. 30, 2023.

(51) Int. Cl. B09C 1/08; B01D 17/02

(52) U.S. Cl. CPC B09C 1/08; B01D 17/0202; B01D 15/00; B09C 2101/00

(57) ABSTRACT

Methods are disclosed for delivering a remedial amendment to a target site. An amendment, potentially along with a binder and/or a disintegrant, may be agglomerated into several agglomerates. These agglomerates may maintain their agglomerated form when transported to a target site. Once the agglomerates have arrived, they may disintegrate in the soil via moisture activation, agitation, or both. When the agglomerates have disintegrated, the amendment may disperse and be delivered to the soil, whereafter the amendment can treat any contaminants in the target site. By delivering the amendment in this manner, one can mitigate dust scattering throughout the surrounding environment.

### CROSS-REFERENCE TO RELATED APPLICATIONS

This application relates to and claims the benefit of U.S. Provisional Application No. 63/604,656 filed Nov. 30, 2023, and entitled “Soil Mixing Processes for Stabilizing Contaminated Soil”, the entire disclosure of which is hereby wholly incorporated by reference.

### STATEMENT RE: FEDERALLY SPONSORED RESEARCH/DEVELOPMENT

Not applicable.

### BACKGROUND

### 1. Field of Invention

The present application relates to the delivery of an amendment to soil to treat a target site while mitigating dust scatter. More specifically, the present application relates to methods wherein an amendment may be formulated into agglomerates, transported to a target site, and applied to soil. Thereafter, the agglomerates may disintegrate such that the amendment is delivered to the target site while mitigating dust scatter to the surrounding environment.

### 2. Related Art

The production, handling and use of chemicals has inadvertently led to their release and undesirable distribution within the environment. Soil and groundwater are media commonly requiring intervention to remove these unwanted chemicals or mitigate their harmful effects. Currently, several technologies are available to treat soils impacted by chemical contamination, which can include metals, petroleum hydrocarbons, herbicides, pesticides, halogenated hydrocarbons, halogenated dibenzodioxins, polychlorinated biphenyls (PCBs), and per- and polyfluoroalkyl substances (PFAS). For highly stable chemicals, such as PFAS, effective remediation technologies include excavation and disposal, sorption and stabilization, soil washing, thermal/smoldering, and more. Among these treatment technologies, the stabilization of the contaminants in the impacted area by mixing a site-specific mixture of amendments can rapidly reduce the mass of contaminants discharged downstream with relatively low energy and time investment. Compositions and methods related to these technique are disclosed in U.S. Patent No. 7,585, 132 entitled “METHOD FOR REMEDIATING A CONTAMINATED SITE”, U.S. Pat. No. 9,770,743 entitled “COLLOIDAL AGENTS FOR AQUIFER REMEDIATION”, U.S. Pat. No. 9,776,898 entitled “TREATMENT OF AQUIFER MATRIX BACK DIFFUSION”, U.S. Pat. No. 10,512,957 entitled “COLLOIDAL AGENTS FOR AQUIFER AND METALS REMEDIATION”, and U.S. Patent Application No. 18/659, 147 entitled “TRACER METHODS FOR THE DETERMINATION OF SORBENT CONTENT IN SOILS”, in which the entire disclosures of each are wholly incorporated herein by reference.

The amendments introduced to the soil in such methods typically include various forms of solid adsorbents which can adsorb the contaminants present in soil and substantially, if not entirely, eliminate the ability of those contaminants to further leach from the solid matrix. These amendments can have various particle sizes, ranging from colloidal, fine powders, or more course materials of significantly larger size. Each amendment particle size range has pros and cons associated therewith. Advantageously, colloidal-sized amendments can be thoroughly dispersed in soils, but they usually require liquid handling and delivery. Powdered amendments also allow for good mixing and dispersion, but such amendments can spread throughout the environment as dust. This dust can easily and inadvertently scatter throughout the environment around a target site due to, for instance, weather effects, handling of the amendment (e.g., opening and moving a bag containing a bulk volume of the amendment can cause dust to fly out), mixing of the amendment in the soil, and handling large amounts of an amendment. Dust scattering in this context may create issues, including inhalation hazards, explosion concerns, and other nuisance issues to neighboring properties and onsite activities. Significant volumes of water are needed to prevent the powdered particles from blowing away and scattering, but even when this precaution is taken, substantial dust scattering may nonetheless occur. Using granular amendments instead can avoid these difficulties, as these amendments are dense enough to where they won't be blown away by wind or mechanical mixing processes, but the coverage of granular amendments can be poor in the same weight percentage as powders and the sorption/immobilization kinetics of these amendments may be suppressed. In addition, the relatively larger particle size can lead to poor utilization of the entire volume of sorbent for immobilization.

To achieve a solution which combines ideal handling and dispersion results, prior attempts have been made to formulate amendments as an agglomerate, which can deliver effective adsorbents to treat contaminants in sediment or wastewater systems by pelletizing sorbents, bentonite clay, and sand. The agglomerated adsorbents can then break down to powdered form after agitation to efficiently adsorb contaminants. However, these prior agglomerates have only proven effective in water-saturated systems, which is not applicable for in-situ soil remediation. Hence, there is a need to improve the mixing processes with alternative materials and techniques.

### BRIEF SUMMARY

To solve these and other problems, methods are contemplated for remediating a target site by formulating an amendment as a water-dispersible agglomerate. An amendment may be agglomerated into serval agglomerates at a location distant from a target site where the amendment will ultimately be delivered. Advantageously, the agglomerates may maintain their agglomerated form when transported and applied upon the soil of the target site. The agglomerate may be capable of disintegrating and releasing the amendment in response to sufficient moisture exposure, sufficient agitation, either, or a sufficient combination of both. By delivering an amendment in this manner, the risk of dust scattering to the surrounding environment may be drastically reduced and thus allow for soils to be treated where such a risk would otherwise discourage or prevent one from treating those soils.

The amendment may include an adsorbent, which may comprise activated carbon, ion exchange resin, clay mineral, modified clay mineral, cyclodextrin polymers, biochar, iron oxides, iron, natural organic matter, or combinations thereof. The amendment may be in a colloidal, powdered, granular, and/or nanoparticle size.

A binder may be included with the amendment when forming an agglomerate. The binder may comprise starch, modified starches, microcrystalline cellulose, gelatin, sucrose, xanthan gum, lignin, lignosulfonate, chitosan, methylcellulose, sodium carboxymethylcellulose, ethylcellulose, clay minerals, or combinations thereof. The binder may help to keep the agglomerate in its agglomerated form prior to initiating the disintegration process.

A disintegrant may also or alternatively be included with the amendment during agglomerate formation. The disintegrant may accelerate the agglomerate disintegration process and react when the agglomerate is exposed to sufficient moisture. The disintegrant may comprise Mucilage of Lepidus sativum, Ispaghula husk/seeds, Hibiscus rosa, xanthan gum, agar and treated agar, guar gum, fenugreek, banana powder, locust bean gum, mango peel pectin, gellan gum, soy polysaccharide, chitin, chitosan, gum Karaya, sodium starch glycolate, crospovidone, croscarmellose sodium, crosslinked alginic acid, ion exchange resins, and combinations thereof.

The process of agglomerating the amendment, optionally with a binder and/or disintegrant, may comprise pin mixing, pan/disc pelletizing, fluidized bed granulation, drum granulation, extrusion or compaction methods, spray drying agglomeration, or combinations thereof. The agglomerates may have a diameter ranging from 0.25 mm to 50 mm. After the agglomerates have been formed, they may be transported to the target site via, for instance, being loaded in a truck, carried on a ship, or both. The agglomerates may travel a distance of at least 1 mile, at least 10 miles, at least 50 miles, at least 100 miles, at least 1,000 miles, or at least 5,000 miles before arriving at the target site.

If sufficient moisture exposure would cause the agglomerates to disintegrate, the moisture required for disintegration can be supplied to the agglomerates from moisture naturally in the soil of the target site. Alternatively, or additionally, the moisture could be supplied to the agglomerates from an external source. The agglomerates may be mixed in the soil via mechanical soil tilling, bucket mixing, auger mixing, or combinations thereof; this mixing may promote disintegration through mixing water with the agglomerates and/or agitating the agglomerates. The mechanism by which agglomerates disintegrate may include swelling, wicking, heat of wetting, a gas-releasing acid-base reaction, deformation recovery, enzymatic reaction, particle repulsive force initiated by water exposure, or combinations thereof.

A homogenizer indicator may be included in the amendment to indicate when the amendment has been homogeneously distributed in a target site. In particular, a homogenizer indicator of colloidal activated carbon may provide a visually conspicuous indication that the amendment has been adequately distributed. One may mix the amendment in the soil of a target site until a homogeneous distribution is achieved, as may be indicated by a homogenous coloration of the soil when colloidal activated carbon is present.

The target site may include contaminants, in which case the amendment and any adsorbents thereof may be suited to treat those contaminants via adsorption. The contaminants may comprise of metals, petroleum hydrocarbons, herbicides, pesticides, halogenated hydrocarbons, halogenated dibenzodioxins, polychlorinated biphenyls (PCBs), per- and polyfluoroalkyl substances (PFAS), or combinations thereof.

All of these embodiments are contemplated to be within the scope of this disclosure. These and other embodiments will become readily apparent to those skilled in the art from the following detailed description of the preferred embodiments, the disclosure not being limited to any particular preferred embodiment.

### BRIEF DESCRIPTION OF THE DRAWINGS

These and other features and advantages of the various embodiments disclosed herein will be better understood with respect to the following description and drawings, in which:

FIG. 1 shows the results of an experiment comparing the visualization of colloidal activated carbon and powdered activated carbon.

### DETAILED DESCRIPTION

Disclosed herein are methods of delivering amendments to a target site by formulating those amendments as water-dispersible agglomerates. By agglomerating an amendment having nanoparticle, colloidal, powdered, and/or granular adsorbents with a binder and a water-activated disintegrant, an agglomerate may be formed which can remain intact while transporting from where the agglomerate was formed to a target site where the amendment will ultimately be delivered. The agglomerates may be capable of disintegrating when sufficiently agitated and/or exposed to sufficient moisture, which could be supplied from the moisture in the soil the agglomerate is applied to and/or from an external source of water. By delivering an amendment in this manner, a target site can be treated effectively while greatly reducing the risk of dust scattering throughout the surrounding environment.

This description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as primary and secondary and the like are used solely to distinguish one from another entity without necessarily requiring or implying any actual such relationship or order between such entities.

At the outset, an amendment may be selected which may be suited to treat a particular target site. Such an amendment may have absorbents, which can include, but are not limited to, activated carbon, ion exchange resin, clay mineral, modified clay mineral, cyclodextrin polymers, biochar, iron oxides, iron, natural organic matter, or combinations thereof. These adsorbents may be in granular, powdered, colloidal, and/or nanoparticle form.

The adsorbent(s) selected may depend on the context the amendment is to be used. For example, if the amendment is to be deployed at a target site having certain soil properties and/or a particular type or concentration of contaminants present or anticipated to be present in the future, the adsorbents may be chosen to achieve ideal distribution in that site and/or effectively treat those contaminants. The decision as to which amendment to deploy for the target site may be based on information from literature, extraction and experimentation upon the soil and/or contaminants from the soil, general knowledge of those skilled in the art, etc. The contaminants which may be targeted by these amendments may include, but are not limited to, metals, petroleum hydrocarbons, herbicides, pesticides, halogenated hydrocarbons, halogenated dibenzodioxins, polychlorinated biphenyls (PCBs), per- and polyfluoroalkyl substances (PFAS), and combinations thereof. If necessary, a step may be taken to acquire or manufacture an appropriate absorbent material. Some adsorbents may be commercially available and ready to be agglomerated, while others may need to be sized down to a preferred powdered or colloidal size via pulverization, wet milling, or other appropriate size reduction methods.

To help form agglomerates of the chosen adsorbent, a binder may also be chosen. Examples of binders suitable for this purpose include, but are not limited to, starch, modified starches, microcrystalline cellulose, gelatin, sucrose, xanthan gum, lignin, lignosulfonate, chitosan, methylcellulose, sodium carboxymethylcellulose, ethylcellulose, clay minerals, and combinations thereof. The binding strength provided by the binder may be a critical property in maintaining and disintegrating the agglomerate, as will be discussed momentarily with respect to agglomerate formation. Ideal binders may not only provide enough binding strength to form the agglomerate but also have little adverse impact on the adsorbent's performance when delivered in the soil. In particular, preferred binders would not inhibit the sorption affinity and capacity of the adsorbents nor cause substantial flocculation of the adsorbents which prevents adequate disintegration. Additionally, binders which can form an effective agglomerate while making up a lower weight percentage of that agglomerate are preferred, since that would allow for a higher concentration of adsorbents to be delivered to target site per agglomerate. It is further contemplated that some binders may provide additional advantages to soil stabilization compared to others, such as reducing the time needed for an agglomerate to disintegrate or enhancing contaminant immobilization.

Disintegrants, particularly super disintegrants (or sometimes referred to as superdisintegrants), may also be included to promote disintegration of the agglomerate when applied to the soil at a target site. Preferably, these disintegrants will only promote disintegration of the agglomerate when exposed to sufficient amounts of water. Suitable disintegrants for such a purpose include Mucilage of Lepidus sativum, Ispaghula husk/seeds, Hibiscus rosa, xanthan gum, agar and treated agar, guar gum, fenugreek, banana powder, locust bean gum, mango peel pectin, gellan gum, soy polysaccharide, chitin, chitosan, gum Karaya, sodium starch glycolate, crospovidone, croscarmellose sodium, crosslinked alginic acid, ion exchange resins, and combinations thereof. Such disintegrants may be required to accelerate the disintegration process to achieve a practically efficient and effective release of the amendment into the soil.

It is contemplated that an agglomerate, potentially with the aid of moisture-activated disintegrants, may disintegrate and release their amendments via numerous potential mechanisms, which will be described in this paragraph. However, it will be noted that there could be additional/alternative mechanisms in which an agglomerate may disintegrate with or without the aid of a disintegrant; in this respect, unknown or future developed disintegrants which can lead to similar disintegration results may be suitably used in the methods disclosed herein. Swelling, whereby the agglomerate swells upon moisture contact and thus allows more water to penetrate and accelerate disintegration, is a particularly effective mechanism. Another effective mechanism is wicking, where water can penetrate a porous agglomerate via capillary action, causing bonds to weaken. For a heat of wetting mechanism, if an exothermic disintegrant is present in an agglomerate, wetting the agglomerate can generate localized stress and break down the agglomerates. If such a reaction exists between a disintegrant and water, a disintegrant may take part in a gas-releasing acid-base reaction to promote disintegration. If a disintegrant is distorted during compression into an agglomerate, it may return to its original structure when the agglomerate is wetted; by expanding is this deformation recovery mechanism, the disintegrants may boost the rate at which the agglomerates disintegrate. If the disintegrants include enzymes, they may reduce the binding forces holding the adsorbent material together in an agglomerate to promote disintegration. Particle repulsive forces can arise when certain disintegrants encounter water, causing the adsorbent material to break apart from the agglomerate.

Once the amendments, binders, and disintegrants have been chosen, an agglomeration process may be performed to form agglomerates. Suitable agglomeration processes include, but are not limited to, pin mixing, pan/disc pelletizing, fluidized bed granulation, drum granulation, extrusion or compaction methods, spray drying agglomeration, and combinations thereof. The suitability of an agglomeration technique, and thus the decision to employ such a technique, may be based on the desired characteristics of the agglomerates to be produced. In particular, ideal agglomerates would remain in the agglomerated form during shipping and handling but disintegrate when desired under the specified moisture and/or agitation conditions. Multiple agglomeration processes can be used, and a particular agglomeration process can be carried out multiple times when forming agglomerated amendments. It can be seen that the properties of agglomerates may vary depending on the chosen amendment, adsorbents, binders, disintegrants, and agglomeration processes, as well as the soil in which the amendment will be deployed upon. Therefore, one may experiment with various combinations and test those combinations on soil samples to determine which combination provides the best balance of agglomerate formation/stabilization and case of disintegration when desired.

The adsorbents may be present in the agglomerates formed at any value from 1%-99%, preferably 50-99%, by weight of an agglomerate. It is contemplated that lower or higher concentrations of adsorbents in an agglomerate may be more suited for particular impacted soil zones/contaminants, as this concentration could determine how aqueous or solid the adsorbent medium is respectively. Binders may be present in a concentration ranging from 0.1-25% by weight of an agglomerate. The disintegrants may be present in a concentration ranging from 0.01-20% by weight of an agglomerate. Multiple, individual agglomerates may be formed during an agglomeration process. The agglomerates formed may have a diameter size ranging from 0.25 mm to 50 mm.

Once the agglomerates have been formed, they may be stored prior to use. Beneficially, the agglomerates may remain in their agglomerated from while stored and kept away from moisture adequate to disintegrate them. Whenever the agglomerates are ready for use, they may be transported from where the agglomerates were formed/stored to the target site to be treated. In this respect, the agglomerate may be transported a distance of at least 1 mile, at least 10 miles, at least 50 miles, at least 100 miles, at least 1,000 miles, or at least 5,000 miles. When transported over a certain distance, the agglomerate may remain intact to an extent that would prevent substantial dust generation. In this respect, at least 80 of the amendment can remain in an agglomerated form when transported over this distance. Vehicles like trucks and ships can be used to transport the agglomerate to the target site over land, sea, or both.

When the agglomerates have arrived at the target site, the agglomerate may be applied to the soil to be treated. While a target site may be one which already has certain contaminants present, it is also contemplated that the target site may be one which is not contaminated at the time the agglomerate is applied; in such a case, the delivery of an adsorbent on that site may serve as a proactive treatment in the event that the target site does become contaminated or is expected to become contaminated in the future. The total amount of amendments delivered to a target site can be described as a weight percentage of the soils, such as in the range 0.5-20% w/w. The appropriate dose may be determined based on the contaminant concentrations, soil properties, a target cleanup criteria (which could be based on a governmental guideline), performing bench-scale tests to quantify the reduction in contaminant leaching after addition of the amendments at various loadings, and combinations thereof. Once the target dose of the appropriate sorbent is determined, one can extrapolate the proper amount of agglomerates needed and transport that amount to the target site.

The agglomerate may readily disintegrate, and thus release the amendments into the soil, in response to sufficient moisture, sufficient agitation, or both. With respect to disintegration by moisture, the moisture content present in the soil may be sufficient to disintegrate the agglomerate. If needed or desired, an external source of water, such as from a local fire hydrant or water transported to the site, may be supplied with a hose to provide moisture sufficient to disintegrate the agglomerates. Preferably, the water supplied from an external source in this manner would not create mud, or at least keep mud generation low, in the target site. The force/moisture required to disintegrate the agglomerates may depend on the combination of adsorbents, binders, disintegrants, and agglomeration processes used to form the agglomerates.

With the agglomerates applied on the soil, the soil may be mixed to promote disintegration of the agglomerates via agitating the agglomerates, mixing water with the agglomerates, or both mechanisms of disintegration. Usable soil mixing techniques include conventional soil treatment methods, like mechanical soil tilling, bucket mixing, auger mixing, the employing specialty soil mixing tools, and combinations thereof.

It can be appreciated that by deploying agglomerates and causing them to disintegrate them upon and within the soil, an amendment and its adsorbents may be delivered and dispersed in a target site while considerably mitigating the risk of dust spreading and scattering into the surrounding environment. Thus, a site may be more readily and extensively treated when such a risk would limit or prevent one from treating that site with an otherwise appropriate amendment.

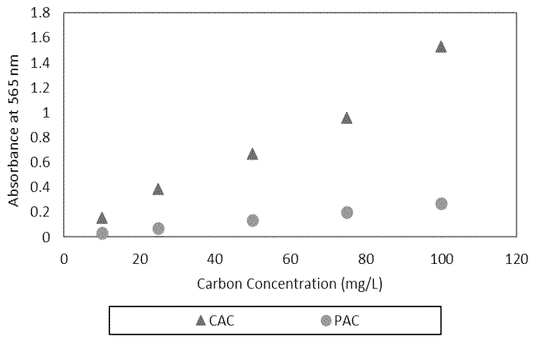

It may be desirable to ensure the amendment is homogeneously mixed in the soil, as this can ensure that any contaminants in the target site become effectively immobilized. However, the components of an amendment may not be visually conspicuous in the soil to a degree which would allow one to visually inspect the soil and discern when the amendment has been homogenously mixed. This may particularly be the case when using a low concentration of amendments relative to the soil mass, as may be the case when treating mildly contaminated sites. While it is common to use a filler (i.e., some inactive ingredient), it would be far more efficient for one of the active species in an amendment to serve this purpose. In particular, colloidal activated carbon (CAC) has been found to be very effective as a homogenizing indicator, due to its dark, discernable color as well as its size, which can coat the soil particle better than powdered activated carbon (PAC). For conventional powdered activated carbon, visual confirmation of distribution becomes a challenge below 0.5% w/w by weight percentage of the soils. As experimentally demonstrated by the difference in optical density between colloidal activated carbon and powdered activated carbon (as discussed in relation to FIG. 1 below), a color change by addition of colloidal activated carbon is noticeable at nearly one tenth of the dose of powdered activated carbon. Therefore, if a target site does not require a large concentration of amendment to treat, such as in the concentration range of 0.1-2% w/w by weight percentage of the soils, colloidal activated carbon can be included in the amendment such that it can serve as a visual indicator that the amendment has been homogeneously mixed in the soil. One can determine that soil is homogenously mixed with colloidal carbon in a manner not possible with powdered activated carbon, and stop mixing that area of a target site, once they observe that the soil turned to a homogenous, dark color. Thus, when mixing an amendment in the soil, the soil may be continually mixed until the soil visually appears to be of a homogeneous coloration.

Referring now to FIG. 1, the results of an experiment comparing the visualization of colloidal activated carbon and powdered activated carbon are shown. A series of solutions with varying carbon concentrations was prepared using either colloidal activated carbon or powdered activated carbon. No dispersants or additional chemicals were included that could interfere with the measurements. The solutions were made in deionized water, containing carbon concentrations of 10, 25, 50, 75, and 100 mg/L. The carbon solutions were placed in a cuvette immediately after being shaken vigorously to measure their ultraviolet absorbance at a wavelength of 565 nm using ultraviolet-visible spectroscopy. The higher absorbance of CAC indicates that it has a better visual impact than PAC at the same weight.

The above description is given by way of example, and not limitation. Given the above disclosure, one skilled in the art could devise variations that are within the scope and spirit of this disclosure. Further, the various features of the embodiments disclosed herein can be used alone, or in varying combinations with each other and are not intended to be limited to the specific combination described herein. Thus, the scope of the claims is not to be limited by the illustrated embodiments. Additional modifications and improvements of the present disclosure may also be apparent to those of ordinary skill in the art. Thus, the particular combination of parts and steps described and illustrated herein is intended to represent only certain embodiments of the present subject matter and is not intended to serve as limitations of alternative devices and methods within the spirit and scope of this disclosure.

What is claimed is:

1. A method of treating contaminants in a target site, the method comprising the steps of:
a) providing an amendment comprising adsorbents, the adsorbents comprising a granular adsorbent, a powdered adsorbent, a colloidal adsorbent, a nanoparticle adsorbent, or combinations thereof;
b) agglomerating the amendment to form agglomerates; and
c) disintegrating the agglomerates via supplying moisture to the agglomerates, agitating the agglomerates, or both;
wherein said disintegrating causes the amendment to be delivered to the target site.

2. The method of claim 1, wherein the adsorbent comprises activated carbon, ion exchange resin, clay mineral, modified clay mineral, cyclodextrin polymers, biochar, iron oxides, iron, natural organic matter, or combinations thereof.

3. The method of claim 1, wherein the method further comprises a step of:
providing a binder;
wherein said step of agglomerating comprises agglomerating the amendment and the binder to form the agglomerates.

4. The method of claim 3, wherein the binder comprises starch, modified starches, microcrystalline cellulose, gelatin, sucrose, xanthan gum, lignin, lignosulfonate, chitosan, methylcellulose, sodium carboxymethylcellulose, ethylcellulose, clay minerals, or combinations thereof.

5. The method of claim 1, wherein said step of agglomerating comprises pin mixing, pan/disc pelletizing, fluidized bed granulation, drum granulation, extrusion or compaction methods, spray drying agglomeration, or combinations thereof.

6. The method of claim 1, wherein the method further comprises a step of:
transporting the agglomerates to the target site;
wherein the agglomerates travel a distance of at least 1 mile during said step of transporting.

7. The method of claim 1, wherein during said step of disintegrating, the moisture is supplied to the agglomerates from soil of the target site.

8. The method of claim 1, wherein during said step of disintegrating, the moisture is supplied to the agglomerates from an external source.

9. The method of claim 1, wherein the target site contains a contaminant, and wherein the adsorbent is capable of adsorbing the contaminant.

10. The method of claim, 9, wherein the contaminant comprises metals, petroleum hydrocarbons, herbicides, pesticides, halogenated hydrocarbons, halogenated dibenzodioxins, polychlorinated biphenyls (PCBs), per- and polyfluoroalkyl substances (PFAS), or combinations thereof.

11. The method of claim 1, wherein the agglomerates have a diameter ranging from 0.25 mm to 50 mm.

12. The method of claim 1, wherein the method further comprises a step of:
providing a disintegrant;
wherein said step of agglomerating comprises agglomerating the amendment and the disintegrant to form the agglomerate.

13. The method of claim 12, wherein the disintegrant comprises: Mucilage of Lepidus sativum, Ispaghula husk/seeds, Hibiscus rosa, xanthan gum, agar and treated agar, guar gum, fenugreek, banana powder, locust bean gum, mango peel pectin, gellan gum, soy polysaccharide, chitin, chitosan, gum Karaya, sodium starch glycolate, crospovidone, croscarmellose sodium, crosslinked alginic acid, ion exchange resins, and combinations thereof.

14. The method of claim 1, wherein during said step of disintegrating, the agglomerates are agitated by mixing the agglomerate with soil of the target site, the mixing comprising mechanical soil tilling, bucket mixing, auger mixing, or combinations thereof.

15. The method of claim 1, wherein during said step of disintegrating, the agglomerates disintegrate at least in part via a mechanism of swelling, wicking, heat of wetting, a gas-releasing acid-base reaction, deformation recovery, enzymatic reaction, particle repulsive force initiated by water exposure, or combinations thereof.

16. A method of treating contaminants in a target site, the method comprising the steps of:
a) providing an amendment comprising adsorbents, the adsorbents comprising a granular adsorbent, a powdered adsorbent, a colloidal adsorbent, a nanoparticle adsorbent, or combinations thereof;
b) agglomerating the amendment, a binder, and a disintegrant to form agglomerates; and
c) disintegrating the agglomerates via supplying moisture to the agglomerates, agitating the agglomerates, or both;
wherein said disintegrating causes the amendment to be delivered to the target site.

17. A method of treating contaminants in a target site, the method comprising the steps of:
a) providing an amendment comprising adsorbents, the adsorbents comprising a granular adsorbent, a powdered adsorbent, a colloidal adsorbent, a nanoparticle adsorbent, or combinations thereof, the amendment further comprising a colloidal activated carbon homogenizer indicator;
b) agglomerating the amendment to form agglomerates;
c) disintegrating the agglomerates via supplying moisture to the agglomerates, agitating the agglomerates, or both; and
d) mixing the amendment in the target site;
wherein said disintegrating causes the amendment to be delivered to the target site; and
wherein said mixing causing the amendment to be homogeneously distributed in the target site.
